(19) United States
(12) Patent Application Publication
(10) Pub. No.: US 2008/0170469 A1
(43) Pub. Date: Jul. 17, 2008

(54) Stabilizing remote clocks in a network

(75) Inventors: Alan R. Phillips, Calgary (CA); Timothy D. Hladik, Calgary (CA)

Correspondence Address: W. ALLEN MARCONTELL, P.O. BOX 800149, HOUSTON, TX, 77280-0149, US

(73) Assignee: ARAM Systems, Ltd., Calgary (CA)

(21) Appl. No.: 12/009,047

(22) Filed: Jan. 16, 2008

Related U.S. Application Data
(60) Provisional application No. 60/880,597, filed on Jan. 16, 2007.

(51) Int. Cl. G01V 1/22

(52) U.S. Cl. 367/76

(57) ABSTRACT

The present invention utilizes signals such as interrogate commands generated from a Master Clock or other High Precision Clocks in a distributed sensor data acquisition system featuring a communications network (such as a land/transition zone seismic data acquisition system) to stabilize the oscillator (timing cycle) frequency of Remote Clocks elsewhere in the network. The disclosed invention is characterized by the utilization of highly stable timing signals from a Master Clock or other High Precision Clocks as a calibration standard to improve the oscillator frequency of distributed Remote Clocks of lesser inherent stability. Implementation of the disclosed invention results in improved synchronization of seismic amplitude data concurrently acquired over a wide area and improved subsurface geologic resolution.

### CROSS-REFERENCE TO RELATED APPLICATIONS

The priority date benefit of Provisional Application No. 60/880,597 titled STABILIZING REMOTE CLOCKS IN A NETWORK filed Jan. 16, 2007 is claimed for this application.

### STATEMENT REGARDING FEDERALLY SPONSORED RESEARCH OR DEVELOPMENT

Not Applicable.

### BACKGROUND OF THE INVENTION

1. Field of the Invention

The present invention relates to seismic survey equipment. In particular, the invention relates to seismic data applications of network synchronization methods and corresponding logistics of equipment deployment.

2. Description of the Related Art

Utilization of a land/transition zone seismic data acquisition system such as the ARAM ARIES system described by U.S. Pat. No. 6,977,867 entails the distribution of seismic sensor groups over a wide geographic area. A precisely located and timed seismic event such as an explosion or Vibroseis™ discharge releases shock (seismic) energy against and into the earth. Each sensor in a group detects the magnitude of such seismic energy received by the sensors and converts the detected energy magnitude to a corresponding electrical signal, either analog or digital. The sensor groups are connected to remote data acquisition modules (RAMs) which are joined to other RAMs and to other data processing/communication modules such as base line units (BLUs) or line tap units (LTUs) by communication signal carriers such as electrical cable, optical fibers or radio linkages that are further connected by appropriate signal carriers to a Central Recording Unit (CRU). As appearing herein, a sensor “group” may comprise one or more geophones, hydrophones or other pressure sensor type (vertical or multi-component) that remains in one position for a period of time, typically at least several days. Such a distributed data acquisition system is disclosed in U.S. Pat. No. 6,977,867.

Preferably, each of the network distributed RAMs includes an operatively combined local clock called a Remote Clock in this document. A Master Clock may be operatively combined with the CRU. The Remote Clocks in the RAMs are desirable for controlling timing of the acquisition and digitization of the seismic amplitudes. Although it is not required that the RAMs sample the seismic amplitudes synchronously, timing integrity must be maintained so that all of the seismic amplitude series can be related to common calendar time (e.g. as provided by a Master Clock synchronized to Coordinated Universal Time) with an accuracy better than 100 microseconds. Other clocks may be positioned at other locations in the network which are of higher precision than the Remote Clocks and of lesser or equal precision relative to the Master Clock.

Timing integrity is necessary for the objectives of the seismic data acquisition process to be met. The acquired seismic data is later subjected to myriad computer processing steps including, for example, the combination of data from a wide area in an imaging process called 3D pre-stack migration. The sensor amplitude data and corresponding times of arrival at the respective sensors, after processing, are indicative of subsurface seismic conditions related to geology and fluid content of geologic formations. Errors in timing acquisition of the original field seismic amplitude data will cause degradation of the final processed data and lead to erroneous interpretation of subsurface geology and fluid distribution.

Networked seismic data acquisition systems for land and marine transition zone application are available in various forms. The system disclosed in U.S. Pat. No. 6,977,867 is a system that employs a half-duplex communication method characterized by utilization of a single data transmission channel between two RAMs, carrying communications both ways; away from the CRU and toward the CRU. The communication method is called half-duplex because at any one moment in time the transmitted data can only be traveling in one direction in a given section of the signal transmission channel. However, at some successive moment in time, data may be traveling in the opposite direction over the same section of signal transmission channel. The transmission of inbound and outbound transmitted data is always done in different time windows. Seismic data acquisition systems available in the market today may be full duplex cable systems, meaning two way transmission is performed simultaneously (using two conductive pairs or a fiber), or they may be half-duplex cable systems or half-duplex radio systems. Full duplex radio systems could be designed (using two bands) but none are presently offered to the industry.

In a half-duplex seismic data acquisition system, it is convenient to provide a Remote Clock in each RAM. The Remote Clock is relied upon for timing the acquisition of sensor data and for controlling the timing of network communication. For example an Interrogate command may be relayed to the next further RAM after a deliberate delay to ensure that seismic data packet from the current cycle has been transmitted toward the CRU before the data packet from the next further RAM arrives for retransmission.

A typical Remote Clock is a temperature compensated crystal oscillator (TCXO) with a stability on the order of 2.5 parts per million (ppm). This drift rate is greater than is desirable and causes the hundreds of RAMs to lose synchronization if not corrected. A more stable oscillator could be chosen for the Remote Clock (such as an oven controlled crystal oscillator (OXCO); however it would require more power which is a critical design factor for the battery-powered RAM and would be more expensive, thereby limiting the commercial competitiveness of a system so equipped.

However, a highly precise instrument with much greater stability than 2.5 ppm may be freely chosen for the CRU Master Clock and this choice is made in all such seismic data acquisition systems. This system Master Clock is the reference which the system designer would prefer for all of the Remote Clocks to stay in synchronization with throughout the period of data acquisition. The Master Clock may be chosen to have a precision of 0.001 ppm for example.

Another approach is described in U.S. Pat. No. 7,269,095 which describes a method of continually updating a seismic system RAM's clock (Remote Clock) with the time of a Master Clock or an estimate of that time garnered from the nearby High Precision Clock. The said U.S. Pat. No. 7,269,095 discloses a seismic data acquisition system which has a Master Clock and Remote Clocks, as described above, but adds at certain network locations, e.g. at selected RAMs, additional High Precision Clocks. Some of these High Precision Clocks (as well as the Master Clock) may rely on timing signals from GPS satellites to gain their stability and tie to calendar time.

Although the proposal of U.S. Pat. No. 7,269,095 may reduce the impact of Remote Clock instability, it does not eliminate it completely. There may still be deleterious effects from poor synchronization at the locations away from the High Precision Clocks and a Master Clock. Frequent resynchronization may be necessitated due to the inherent instability of the remote clocks and uncertainty in propagation time over extended network signal pathways.

Reliance on GPS timing at all RAM locations has also been proposed as a solution to the timing requirements of a seismic data acquisition system as specified in U.S. Pat. No. 6,553,316 to Bary et al except that it cannot work if GPS signals cannot be received, such as under extremely heavy canopy or underwater. Also the cost of putting GPS receivers at each and every RAM would be a significant consideration and would affect the economic competitiveness of this timing solution.

On the other hand, if an extremely accurate clock were available to a GPS receiver it would allow improved determination of position by that GPS receiver. To this point, a GPS receiver could determine its position more accurately when only three satellites were available using an independent extremely accurate clock. Normally, four satellites are required to correct for timing uncertainty. So a GPS receiver in a seismic data acquisition network could enjoy improved positioning accuracy through utilization of independently provided enhanced-precision timing as described hereafter.

The prior art fails to teach any method or apparatus capable of stabilizing a drift-prone Remote Clock in a network so that it can approach the stability of a Master Clock at a central location or the stability of a proximate High Precision Clock.

### SUMMARY OF THE INVENTION

The present invention is of a novel method and apparatus for utilizing synchronization signals such as interrogate commands generated from the location of a Master Clock or other High Precision Clocks in a distributed sensor data acquisition system featuring a communications network (such as a land/transition zone seismic data acquisition system) to stabilize the oscillator frequency (which controls the clock rate) of Remote Clocks located elsewhere in the network. The disclosed invention is characterized by the utilization of highly stable timing signals from a Master Clock or other High Precision Clocks as a calibration standard to improve the oscillator stability of distributed Remote Clocks of lesser inherent stability. Implementation of the disclosed invention results in improved synchronization of seismic amplitude data concurrently acquired over a wide area and improved subsurface geologic resolution.

### BRIEF DESCRIPTION OF THE DRAWINGS

The advantages and further aspects of the invention will be readily appreciated by those of ordinary skill in the art as the same becomes better understood by reference to the following detailed description when considered in conjunction with the accompanying drawings in which like reference characters designate like or similar elements throughout.

FIG. 1 is a schematic representation of a typical seismic survey field layout.

FIG. 2 is a schematic representation of a seismic survey field layout combining wired and wireless connections between various network elements including a Central Recording Unit, a Master Clock, High Precision Clocks and RAMs.

FIG. 3 is a schematic drawing of a High Precision Clock module according to the present invention.

FIG. 4 is a schematic drawing of a wireless data acquisition module (RAM) containing a Remote Clock according to the present invention.

FIG. 5 is a representative signal composite for an OCXO Master Clock having a stability of 0.001 ppm

FIG. 6 is a representative signal composite for a TCXO RAM Clock having a stability of 2.5 ppm

FIG. 7 is a comparative clock phase trace for a fast running TCXO RAM Clock.

FIG. 8 is a comparative clock phase trace for a slow running TCXO RAM Clock.

FIG. 9 is a comparative performance chart for a seismic system containing 10 RAMs connected along a single network path.

### DESCRIPTION OF THE PREFERRED EMBODIMENTS

The methods and apparatus disclosed in U.S. Pat. No. 7,269,095 are relevant to the new invention and that disclosure is incorporated herein for reference and combination with this new invention, as may be useful in the implementation of the new invention. The methods disclosed in U.S. Pat. No. 7,269,095 provide a means of synchronizing a Remote Clock to the Master Clock or proximate High Precision Clock but do not in any way effect a stabilization improvement in the Remote Clock (or clocks). The synchronization process brings the two clocks to the same or very nearly the same calendar time at the instant of synchronization. However, if the Remote Clock suffers from clock drift at near its maximum specified rate (such as 2.5 ppm) due to inherent instability of its oscillator, the synchronization procedure must be repeatedly applied to keep the clocks closely synchronized.

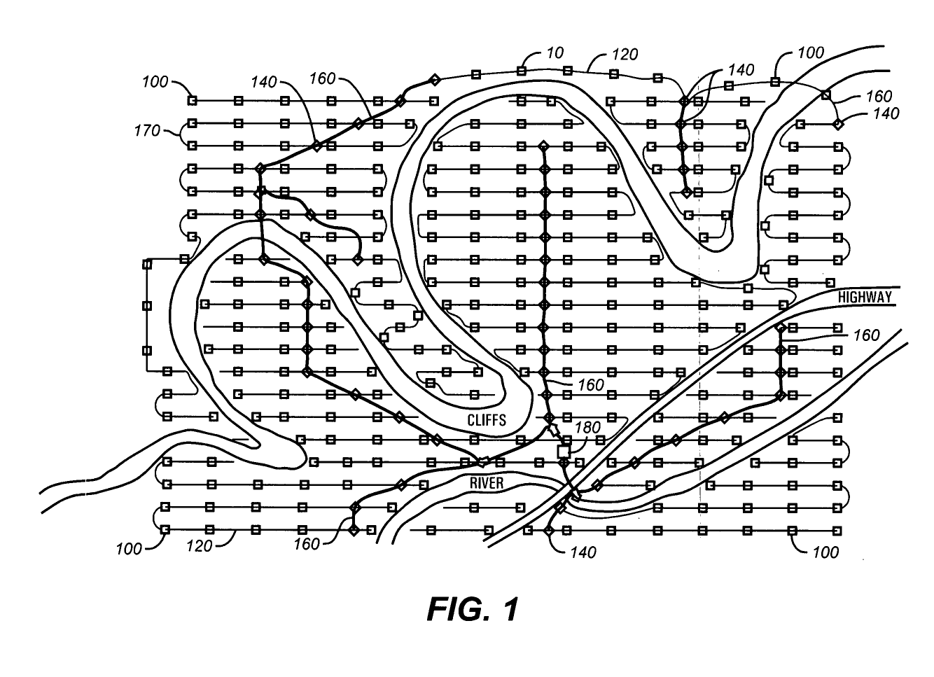

For reference, a typical seismic survey grid is shown schematically by FIG. 1 to include a large number of remote acquisition modules (RAMs) 100 having orderly connections along receiver lines 120 to respective line tap units 140. Line tap units (LTUs) 140 connect receiver lines 120 to base lines 160. The base lines 160 connect ultimately to the central recording unit (CRU) 180. Jumpers 170 connect ends of receiver lines 120 to form loops. RAMs 100 perform functions of collecting sensor group signals, digitizing these signals if they are not already digitized within the groups, and transmitting the data toward the CRU 180. Also, the RAMs 100 receive communications originated by the CRU 180 and by more remote RAMs 100 and relaying this information to adjacent RAMs 100 or LTUs 140.

Sensors may be of one or more types of transducers such as geophones or hydrophones. A signal acquisition channel will acquire data from either a single sensor or a group of sensors.

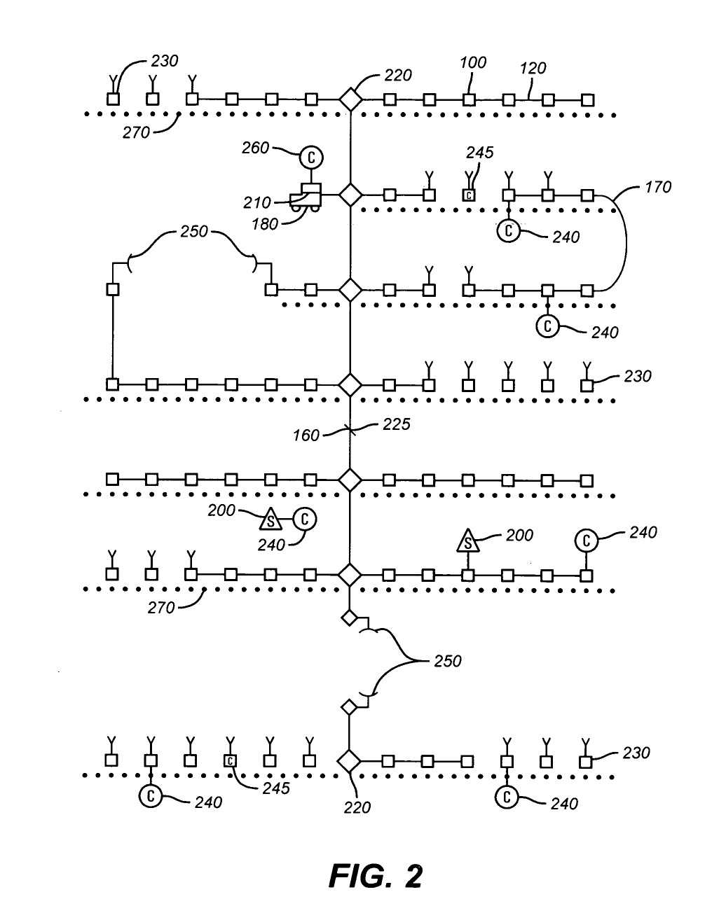

The seismic source units under the control of source event generators 200 (FIG. 2) create the seismic waves that travel into the subsurface and reflect upward to the surface where they are detected by the sensor groups connected to the RAMs 100. The various RAMs, receiver lines, LTUs, base lines, jumpers, the source event generators and CRU perform as a seismic communications network, and also as a seismic data acquisition system, according to the commands emanating from the CRU 180. Receiver line segments and base line segments may be physically realized by employment of sections of cable. The cable may contain electrical conductors or optical fibers (of a combination thereof) to carry signals in both directions, logically toward or away from the CRU 180.

Alternatively, radio or light wave communications may replace the conventional cable sections connecting the various modules shown in FIG. 1 so that cables are not required for communication yet may still be required for connecting sensor groups to the RAMs 100.

FIG. 2 provides a map view schematic diagram of a seismic data acquisition network system so configured, with some wireless RAMs 230 situated wherever it is more convenient to bypass obstacles using wireless connections. Point-to-point wireless links 250 may likewise be utilized to bypass obstacles along the base line. A combination of wired and wireless network elements makes up the hybrid total network.

Seismic event generators 200 are actuated under control of the CRU's 180 control electronics 210 according to the dictates of the human operator. The control electronics 210 may also include a master clock 260 as the basic or independent timing source for the system operation. The various cable sections and modules, as well as the control electronics 210 may be frequently repositioned during the course of the seismic survey. The area of the survey may be water-covered, even to depths in excess of 100 m, partially submerged or wholly dry land. Therefore the operator wishes to have reliable and robust equipment that can be readily reconfigured for each new physical location and position within the network, and be readily and reliably synchronized under these diverse conditions.

Commands and data emanating from a central point in the network, such as from the CRU 180 of control electronics 210 in FIG. 1 or FIG. 2 travel from the originating point along the provided wired or wireless transmission pathways to the adjacent network modules, either LTUs (140), high speed LTUs (220), point-to-point wireless links 250 or RAMs (100 or 230) in proximity to the CRU 180 (more specifically, its control electronics 210) and are relayed from there to the next adjacent network module. This process continues progressively from modules nearer to the CRU 180 to adjacent modules which are one step further from the CRU 180, and so on, until the furthermost modules in the network receive the commands and data. (“adjacent” or “in proximity” here means “logical proximity” in a network definition sense. Physical position may not conform exactly to the descriptors “adjacent” or “in proximity” in a network sense.)

The network shown in FIG. 2 contains a high-speed backbone 225 and high speed LTUs 220. This high-speed backbone might be, for example, a fiber-optic linkage. It is designed to have greater bandwidth and smaller communication delays than that of the cable receiver lines 120 and their LTUs 140. Nevertheless, a small delay will be characteristic of each element of the high speed backbone.

The networked LTUs and RAMs are designed to receive commands and data from a neighboring RAM or LTU on one physical side, and retransmit the command or data to a neighboring RAM on its other physical side. In this fashion commands and data can reach all RAMs in the network. The length of time it takes commands or data to travel from the CRU 180 to any particular RAM or LTU in the network is not entirely predictable. Every time one RAM or LTU repeats another module's commands or data, a small but significant timing uncertainty is added to the propagation time of the command or data. The timing uncertainty can not be adequately resolved by reliance on the Remote Clock (one of which is contained in every RAM and every LTU) due to the inherent instability of the Remote Clock. This timing uncertainty limits the degree to which RAMs (and LTUs) can be synchronized. In prior art systems this in turn results in data detected by the sensor groups being sampled at the wrong instants in time.

To help overcome the synchronization problem, one or more High Precision Clocks 240 may be added among the network of RAMs. These High Precision Clocks 240 help correct for the timing uncertainty associated with the propagation of commands and data throughout the network. The High Precision Clocks 240 can take various forms and can be located internally or externally to the RAMs and LTUs.

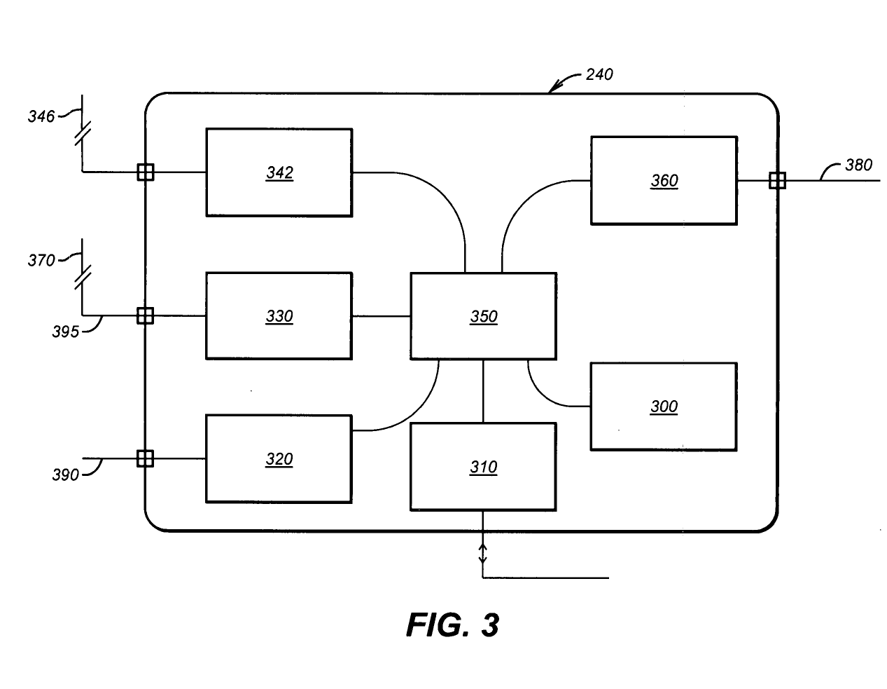

FIG. 3 is a schematic drawing of the High Precision Clock 240. In one application, the High Precision Clock 240 relies solely on its internal oscillator 300 for its time keeping (after synchronization with the CPU 180 Master Clock 260). If a GPS module 340 is utilized, however, both the High Precision Clock and the GPS module 340 are utilized together in time keeping. In another mode, the radio beacon signals instead of GPS time signals are utilized together with the High Precision Clock. The High Precision Clock 240 is typically based on a high precision oscillator capable of time keeping with errors significantly less than 2.5 ppm to as little as 0.001 ppm. In another embodiment, the High Precision Clock 240 may possess an oscillator of lower precision, even approaching 2.5 ppm, but rely on the GPS module 340 or radio beacon signals to attain high precision. In this embodiment the highly precise GPS time signals or radio beacon signals are used to continually correct the drift of the less precise clock, and in this way the High Precision Clock 240 does achieve high precision.

The High Precision Clock 240 includes a RAM interface 310 enabling it to be connected to a wireless RAM 230. A wired clock interface and synchronization module 320 connected to a High Precision Clock wired linkage 390 provides a means for physical connection to another High Precision Clock 240 for purposes of synchronization. A wireless clock interface and synchronization module 330, utilizing radio beacon signals received by clock antenna 395, provides a parallel capability for synchronization without physical connection to another module. In another mode, GPS antenna 370 connects to GPS module 340 providing a means of receiving and processing GPS signals useful for positioning as well as precise synchronization. Seismic event controller 360 and event controller linkage 380 provide a means to communicate with source event generators 200. This linkage may be wired or wireless. The DSP controller and timer 350 controls the other modules and is responsible for the primary time-keeping, synchronization and communication functions of the High Precision Clock 240.

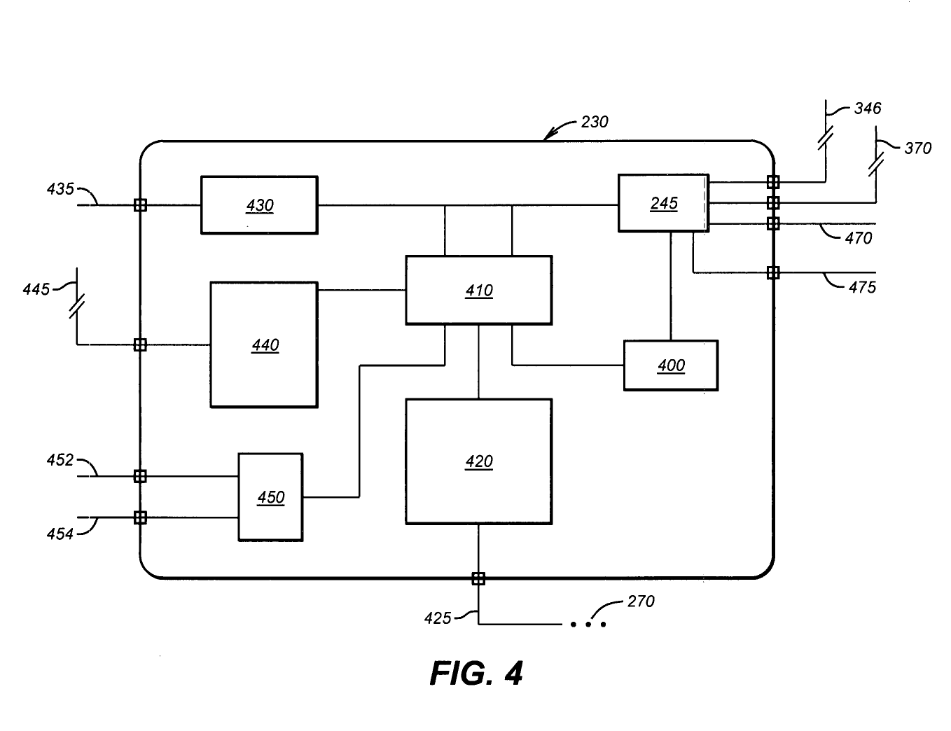

FIG. 4 is a schematic drawing of a wireless data acquisition module (RAM 230) according to the preferred embodiment. The analog, analog-to-digital circuitry and test circuitry 420 provides the functionality for converting the analog signals from one or more seismic sensor groups 425 containing the seismic sensors 270 comprising geophones and/or hydrophone transducers. This circuitry 420 is connected to a DSP controller 410 that also interfaces to the other principle components of the RAM 230 and controls their functions. An internal clock 400 contains a TCXO (Temperature Compensated Crystal Oscillator) or equivalent oscillator circuit with time-keeping precision on the order of 2.5 ppm. In this specification, this internal clock 400 is referred to as a “Remote Clock”.

A wireless radio transceiver 440 served by antenna 445 is also controlled by the DSP 410 for purposes of network communication. Additionally, a communication module 450 is connected to the DSP controller 410 to provide a second means of communication by conventional wired network linkage. Communication linkage 452 connects the communication module 450 to the previous network device (nearer the CRU 180 in a network sense) and communication linkage 454 connects module 450 to the next network device along the cable (further from the CRU 180).

A RAM 230 optionally may include an internal High Precision Clock 245. In the preferred embodiment, this module 245 contains a GPS module 340 and an oscillator circuit that may be based on a TCXO oscillator with precision such as 2.5 ppm, less precise than an oscillator that might be used in an external High Precision Clock 240, and also requiring less power, a critical design factor for the RAM 230. GPS antenna 460 provides a means of receiving GPS signals which are processed by the GPS module 340 within the internal high precision clock module 245. Clock antenna 465 provides for reception of radio signals from a project local, regional or global beacon containing precise timing information. These signals are also processed within the internal High Precision Clock 245. Two further external linkages to the internal High Precision Clock 245 are the wired High Precision Clock linkage 470 for use if the RAM 230 is to be connected with an external High Precision Clock and a linkage 475 that connects to a seismic source event generator 200. A mobile clock module interface 430 and linkage to a mobile clock 435 provide a facility for rapid temporary connection of the RAM 230 to a High Precision Clock 240 for purposes of synchronizing the RAM Remote Clock 400 and/or the optional internal High Precision Clock 245.

A “synchronization signal” may be a formatted information packet such as an Interrogate Command. The Interrogate Command also serves the purpose of controlling the acquisition and transmission of seismic amplitude data by the RAMs. Also it may carry the time of the Master Clock 260 (FIG. 2) at the instant of its transmission.

The total travel path of the synchronization signal begins at the CRU 180 and proceeds to a first remote module (albeit a LTU, BLU or RAM) and thence is relayed through a second transmission to a next closest remote module over a linkage such as conventional wire cable, fiberoptic cable, hybrid cable, or is sent through the intervening space as an electromagnetic (radio or light) wave transmission. The synchronization signal is received and retransmitted by each remote module along its total travel path to a destination RAM. Each RAM relays the synchronization signal to the next further RAM until the final RAM in the logical network travel path is reached.

Because the time each step of communication should take is known a priori, a synchronization signal (such as an Interrogate Command) embodied as a data packet for network communication purposes, and containing the encoded time of the Master Clock 260 at the CRU 180 at the instant of transmission from the CRU, can be used to set the Remote Clock in the receiving first remote module, upon receipt and decoding by that module, by simple addition of the encoded time and the known time duration for communication over the given travel path and setting the Remote Clock to that time. This process synchronizes the Remote Clock of the first remote module to the Master Clock 260.

There will be some error in this process because the actual travel may take slightly more or slightly less time than predicted time known a priori. Repeated measurements of the travel time for the same travel path can be shown to have a small spread of measured values around the average value. This “jitter” is sufficiently small in magnitude for the system components of a modern networked seismic data acquisition system.

The first remote module retransmits the synchronization signal to the next (second) remote module. The re-transmitted synchronization signal may carry the encoded time of the Master Clock 260 at the time of original transmission from the CRU 180, or it may carry the estimated time (calculated using the a priori travel time and time taken between receipt and retransmission) of the Master Clock at the instant of retransmission. In either of these two implementation methods, the next (second) remote module is provided with the necessary information that allows it to set its own Remote Clock to the current estimated time of the Master Clock, i.e. allows it to synchronize.

This process of transmission to a next further remote module, reception by that module, determination of current estimated time of the Master Clock, synchronizing the Remote Clock of the receiving remote module, and sending another synchronization signal (packet) to the next (even) further remote module (said packet containing the encoded Master Clock time or information necessary for computing the Master Clock time) continues. It continues from module to module until the most distant (in a network sense of distance, not physical distance) module from the CRU is reached. Each remote module along the total network travel path for the furthest remote module synchronizes its Remote Clock to the calculated estimate of the Master Clock time upon receipt of the synchronization signal.

The process of synchronizing the entire network, including all LTUs and RAMs, to the Master Clock 260 is undertaken just prior to the beginning of a period of seismic data acquisition and frequently thereafter, as is necessary to maintain a desired accuracy of synchronization (if the novel method of this invention is utilized this will greatly reduce or eliminate the need for any resynchronization). Initial synchronization of the network may be done in two stages, first synchronization of the High Precision Clocks throughout the network, and subsequently, synchronization of the remainder of the clocks. Each LTU and RAM that does not possess a High Precision Clock will have its Remote Clock synchronized in the second stage. After the second stage of synchronization, the accuracy of sample times of the sensor group data by the RAMs will be within the desired limits of accuracy for a period of time. The inherent instability of the Remote Clocks will rapidly cause them to drift from synchronization unless the novel method of this invention, later described, is utilized.

The foregoing text describes the process for the calendar time network based synchronization of a Remote Clock by a Master Clock or other High Precision Clock. This method can be applied at the beginning of a period of network activity or at any subsequent time. If the inherent drift of a Remote Clock could first be stabilized by the novel method next described, it would be advantageous to apply the calendar time synchronization in a second stage. This could provide not only a very stable Remote Clock but also one that can be interpreted in terms of calendar time in synchronization with the Master Clock or proximate High Precision Clock. The two methods may be advantageously combined to achieve a Remote Clock performance with the stability of the Master Clock and which is also synchronized in calendar time (such as UTC or Coordinated Universal Time) to the Master Clock. Both aspects and the combination thereof are invaluable in a networked distributed seismic data acquisition system and other similar distributed systems requiring accurate and precise timing.

### Remote Clock Stabilization

The present process for stabilizing the frequency of Remote Clock timing pulses disclosed herein, has the objective of using the timing pulse frequency (the oscillator signal or derivative thereof of the Master Clock 260, or other network positioned High Precision Clocks, as a calibration reference to stabilize and thereby render more accurate the Remote Clocks distributed geographically and connected together by the communications network.

The communications network may be a half-duplex or full duplex electric cable, fiber optic or radio system. It may also be a combination of radio for certain transmission paths and electric cable or fiber optic for other transmission paths. The cable may contain electrical conductors and it may contain fiberoptic conductors or a combination of electrical and fiberoptic conductors.

In a presently preferred embodiment of the invention, the communication linkages in a half-duplex implementation are used for information transfer in the form of digital data packets which may travel outward from the CRU toward the RAMs or inward from the RAMs toward the CRU over the same communication pathway such as a conductive wire in a cable or a radio link. However, at any one instant, the direction of packet travel is one way only (in a half-duplex system). Inward and outward bound packets may not be sent simultaneously.

During active seismic data acquisition, special packets of digital signal representation called “Interrogate Commands” are sent from the CRU 180 at every desired sample time, for example every 2 milliseconds. At each module, the Interrogate Command is received and then retransmitted away from the CRU. The retransmission of an Interrogate Command by a first RAM to a second, more distant RAM may be delayed until most of the first RAM's entire current seismic data packet has been transmitted toward the CRU. This first Ram data transmission begins as soon as an Interrogate Command is received by the first RAM. The retransmission of the Interrogate Command by the first RAM to the second Ram is timed to coordinate the arrival of second RAM's seismic data at the first RAM just as the last digital bits of the seismic data packet from the first RAM data are transmitted toward the CRU.

The communication frequency chosen for cable transmission may be in the range of 2 to 20 megabits per second, for example. The particular frequency chosen for the communication may be a function of the cable length and type of conductors and also accounting for project requirements in terms of data volume. The communication frequency that is chosen and employed is implemented based on the signal output by the oscillator in the communicating module and the accuracy of implementation of the intended frequency is directly dependent on the accuracy of the oscillator itself. Any deviation in the oscillator frequency from that intended will render the communication frequency similarly inaccurate. Phase drift between the incoming signal from the prior module in the network and the signal derived from the local oscillator is indicative of drift in the time-keeping of the local oscillator relative to the clock in the prior module.

The Master Clock may be an OCXO with a stability of 0.001 ppm for example. The Remote Clocks may be voltage controlled TCXOs with a stability of 2.5 ppm, for example. Characteristically, the oscillator frequency of a TCXO clock is variably responsive to the drive voltage. Hence, the oscillator frequency of a TCXO clock may be adjusted by a corresponding adjustment of the clock drive voltage. Normally, it is not economically wise to use the higher quality OCXO clocks in the remote modules because of their greater cost and higher power consumption relative to a TCXO clock. However, the practitioner desires the very accurate timing of seismic sampling that an OCXO clock could provide if it were controlling the RAM.

The advantage of extremely stable time-keeping and lower power consumption that is desired and useful can be achieved with TCXO clocks in the RAMs by utilizing the method of this invention as described by the following text.

The Master Clock is used to form an oscillator signal by methods familiar to practitioners of the electronic arts. The oscillator signal is modulated such that a signal peaking at the frequency chosen for data transmission, for example 6 MHz, is chosen. An information packet such as an Interrogate Command is encoded on this bit stream as a series of 1 s and 0 s and transmitted to the nearest remote module, which may be for example, a RAM (alternatively, it could be a BLU or LTU) possessing a Remote Clock. In the case of the first Interrogate Command at the beginning of a period of seismic data acquisition received by the RAM, the RAM compares the phase of this first received signal to the phase of an oscillator signal generated by its own clock. This first phase comparison result is recorded in the local RAM memory. However, no further action is taken to speed up or slow down the local RAM clock,

The phase comparison is computed in terms of a fractional portion of a period of the transmission frequency, with a resolution of, for example, ⅛ of a cycle.

For the second and all subsequent Interrogate Commands received in the sequence (which arrive in this example every 2 milliseconds), the same type of phase comparison is computed. If there is no difference in phase between the first and the second Interrogate Command phases no action is taken to speed up or slow down the RAM's (remote) clock. However, if there is a difference in phase, an action may be taken immediately to slow down or speed up the Remote Clock—or else the phase difference is stored temporarily for future reference and possible action to change the clock rate. The amount by which the clock is slowed down or speeded up may be a predetermined value and the same in every instance.

The predetermined percentage amount by which the Remote Clock's oscillator is speeded up or slowed down may be chosen such that it would cause, for example, approximately ⅛ of a period change in the phase comparison for the next Interrogate Command (ignoring the effects of jitter in a single transmission and reception). The amount by which the RAM clock rate is changed should not be so great as to cause misidentification of the particular cycle of interest (as can be caused by cycle skipping) in the next phase comparison.

In every case the phase of the current Interrogate Command signal is saved and is used as the reference in the next phase comparison. The prior Interrogate Command is discarded after its phase has been compared to that of the new Interrogate Command.

The results of a sequence of phase comparisons, for example 8 sequential comparisons may be processed such as by application of a filter to produce a result that indicates whether (a) to speed up the Remote Clock, or (b) to slow down the Remote Clock, or (c) to neither speed up or slow down the Remote Clock.

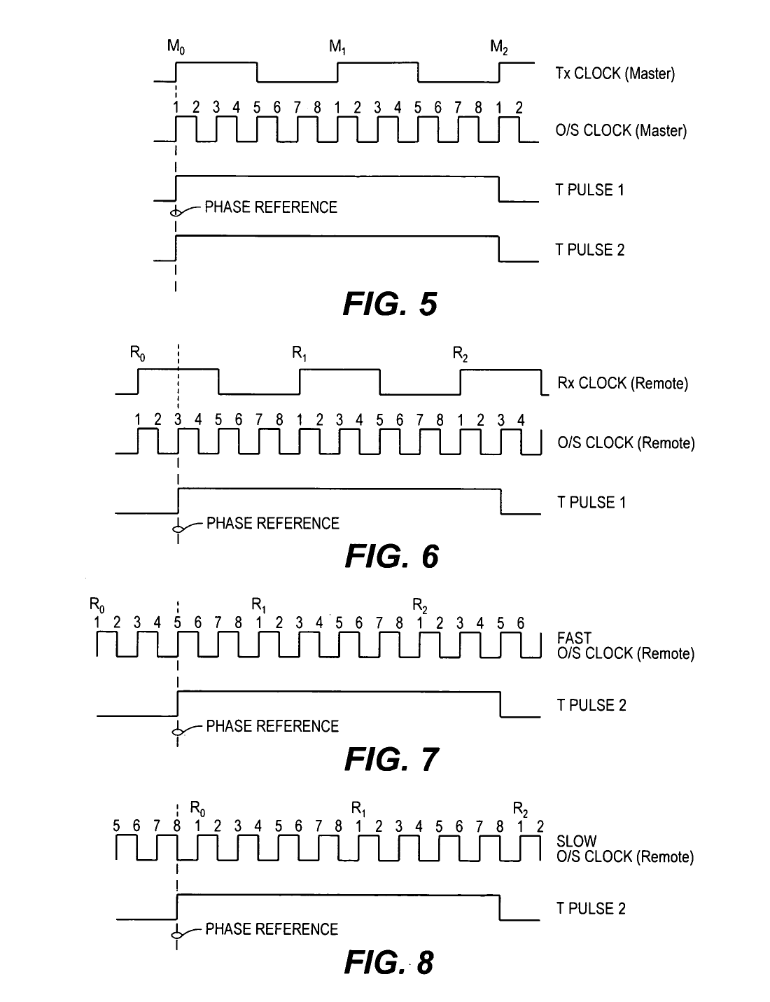

The foregoing process description is graphically represented by the several drawing figures. A Master Clock generates and transmits a delineated sequence of reference timing cycles, two of which are represented by the timing period trace T_{X} shown by FIG. 5. The Master Clock timing trace Tₓ is aligned above a corresponding second delineated sequence (O/S) of timing cycles generated by a remote (subordinate) clock. The remote clock trace O/S divides one timing cycle M₀ to M₁ of the Master Clock period into 8 phase segments. The Phase Reference corresponds with the starting instant M₀ of a Master Clock timing cycle and the leading phase edge 1 of an O/S timing cycle. The T pulse 1 trace represents a data bit from a synchronization signal transmitted by the CRU such as an Interrogate Command. The T pulse1 trace is initiated at the Phase Reference M₀. The T pulse2 trace represents a successive synchronization signal that is also initiated by the CRU at the cyclical instant M₀.

The three signal traces of FIG. 6 pertain to a randomly selected RAM (Remote) Clock. The RAM Clock timing period trace R_{X} has a clock cycle of R₀ to R₁ that substantially corresponds to the timing cycle M₀ to M₁ of the Master Clock. However, the leading edge R₀ of the timing period Rₓ is off-set from the instant of Phase Reference. This off-set represents a ¼ cycle of asynchronization between the Master Clock and the RAM Clock. The 8 phase clock trace generated by the RAM Clock is correspondingly off-set from the instant of Phase Reference. The instant of Phase Reference is determined by arrival at the remote RAM of the leading edge of the synchronization signal T pulse1. As represented by FIG. 6, the arrival instant of the T pulse 1 signal leading edge corresponds to the leading edge of the remote clock phase segment 3. It is the correspondence of the segment edge 3 with the leading edge of synchronization signal T pulse 1 that is recorded for future comparison.

The two signal traces of FIG. 7 illustrate the consequence of a fast running RAM Clock. Here, the leading edge of synchronization signal T pulse2 (see FIG. 5) arrives at a moment that corresponds with the RAM Clock segment edge 5. In the interval between synchronization signals T pulse1 and T pulse2, the RAM Clock timing cycle has gained ¼ of a cycle period relative to the Master Clock.

The two signal traces of FIG. 8 illustrate the consequences of a of a slow running RAM Clock. The leading edge of synchronization signal T pulse 2 (FIG. 5) arrives at a moment that corresponds with the RAM Clock segment edge 8 of the timing cycle following that of R₀ to R₁. In the interval between synchronization signal T pulse1 and T pulse2, the RAM Clock timing cycle has lost ⅜ of a cycle period relative to the Master Clock.

Because there is inevitable time jitter in the received bit stream, albeit very small in magnitude, it is useful to do some filtering or other processing to ensure there is consistency in the sequential phase comparisons for a series of Interrogate Commands before action is taken to adjust the frequency of the Remote Clock oscillator. In one implementation, the practitioner might require a short series of consecutive phase comparisons to be in agreement before action is taken to adjust the Remote Clock. In the case of applying a stability filter as preferred, eight consecutive measurements, for example, may be made before the Remote Clock rate would be reduced. It is important to retain the most recent phase comparisons to effect this variation of the method.

The process of receiving Interrogate Commands, computing phase difference relative to the Remote Clock, further comparing or otherwise processing phase differences of consecutive Interrogate Commands, determining from this whether the Remote Clock oscillator frequency should be increased, reduced, or unchanged, and making the predetermined percentage adjustment in clock rate, continues until the stream of Interrogate Commands ceases.

A cessation of interrogate commands is normally due to the completion of the period of continuous seismic data acquisition. At this time the Remote Clock rate is not further adjusted. After a short period, another period of seismic data acquisition may ensue and the processes defined above are resumed.

In an alternative implementation, another type of data packet could be used in lieu of the Interrogate Command, and could provide for continuous stabilization of the Remote Clocks, even when no seismic data is being acquired. This approach would have an advantage that there could be no relapse of the Remote Clock stabilization process during quiescence of seismic data acquisition.

The disadvantage of using the Interrogate Command for purposes of Remote Clock stabilization is not a severe impediment if the Remote Clocks rapidly stabilize, e.g. within 100 milliseconds. If not, it would be preferable to use the continuous stabilization method.

The Master Clock stabilizes the Remote Clocks in immediately adjacent remote modules (RAMs, BLUs and LTUs). Each of these once-removed modules retransmits the Interrogate Commands to the next further module on its network pathway.

The same procedures as described above for the first module are followed for the next further module. Thus the Remote Clock stabilization process progresses outward from the Master Clock at the CRU. Ultimately the furthest RAMs of the seismic data acquisition network are reached by the Interrogate Commands sent by their neighboring modules. The Interrogate Command signal sequence and outward progress of Remote Clock stabilization processes continue and all of the Remote Clocks in the entire network rapidly achieve the level of clock stability approaching or attaining that of the Master Clock.

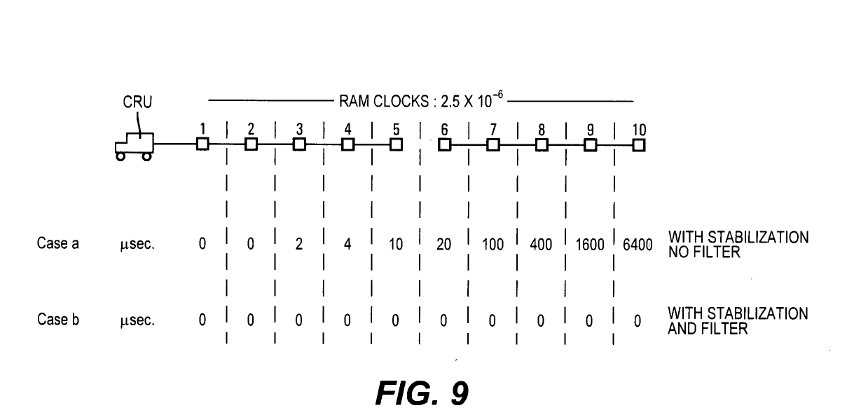

FIG. 9 illustrates a typical physical configuration of the CRU and a series of RAMs connected along a receiver line and to the CRU. A Master Clock with stability of 0.001 ppm is an integral component of the CRU and controls system timing. It is optionally linked to a GPS receiver and in this case can be synchronized to GPS time. Each RAM possesses a Remote Clock with a stability of 2.5 ppm.

If left to run freely, after 1000 seconds the Master Clock can have drifted as much as plus or minus one microsecond. The Remote Clocks in the RAMs can have drifted as much as plus or minus 2.5 milliseconds, enough error to seriously compromise timing of seismic amplitude measurements.

In a laboratory experiment using field equipment and clocks of the designated stability, the stabilization method of this invention was applied (a) with no filtering, and (b) with a stabilization filter requiring eight consecutive phase measurements to be in agreement for a change in clock rate to be implemented. In the case (a), illustrated by FIG. 9, stability was achieved on the nearest Remote Clocks to the CRU, but an error accumulated progressively away from the CRU. In case (b) of FIG. 9, the goal of stability equivalent to the Master Clock was attained even to the 10^{th} RAM away from the CRU. Thus the stabilization filter method was found to be an essential process in this Remote Clock Stabilization method.

In the previous illustrative examples the timing reference has been described as being the Master Clock. In an alternative implementation of the invention a High Precision Clock may be used instead of the Master Clock as the timing reference for stabilization of those Remote Clocks in network proximity to the High Precision Clock. This implementation requires fewer transmissions from module to module between the reference clock and the Remote Clock. Therefore, it may be advantageous in that any cumulative effects of transmission time jitter are lessened. The calendar time may also be sourced from the nearby High Precision Clock rather than the Master Clock in this implementation. As disclosed herein the High Precision Clock may rely on GPS satellite signals or other broadcast radio signals for its timing reference (as interpolated with its own local high precision oscillator). The High Precision Clocks can also be synchronized with the Master Clock by other means at the beginning of the project and periodically at later times during the seismic data acquisition phase of the project as described in earlier sections of this disclosure.

Note that the novel process of clock stabilization taught by this invention does not synchronize the Remote Clocks to the Master Clock (or proximate High Precision Clock) in terms of time-of-day and calendar time. This kind of synchronization is discussed in earlier sections of this specification.

The two methods can be combined to provide in one network at all modules the advantages of highly stable time keeping and synchronization of all Remote Clocks to the Master Clock or proximate High Precision Clocks. This can facilitate correct processing of recorded seismic data from source events that were initiated at a known instant in terms of time of day and calendar time, if both the shot and the data acquisition are timed according to the Master Clock or other High Precision Clocks in the network.

Although the invention has been described above in the environmental setting of a seismic data acquisition system having art characterizations of Master Clocks, High Precision Clocks and Remote Clocks, those of skill in the arts of high speed, large volume electronic telemetry will recognize the disclosure as fundamentally representing a process for controlling the synchronization relationship between a Reference Clock and a Subordinate Clock

Furthermore, while the invention has been described in terms of specified and presently preferred embodiments which are set forth in detail, it should be understood that this is by illustration only and that the invention is not necessarily limited thereto. Alternative embodiments and operating techniques will become apparent to those of ordinary skill in the art in view of the present disclosure. Accordingly, modifications of the invention are contemplated which may be made without departing from the spirit of the claimed invention.

1. A method of coordinating the timing cycle frequency of a subordinate clock to that of a reference clock, said clocks being components of communicating modules in a communications network, comprising the steps of:
transmitting from said reference clock a synchronization signal comprising a first delineated sequence of reference timing cycles;
generating by said subordinate clock a second delineated sequence of subordinate timing cycles substantially corresponding to said reference timing cycles;
receiving said synchronization signal by said subordinate clock;
comparing and recording a first phase displacement between a reference timing cycle and a subordinate timing cycle;
comparing and recording a subsequent phase displacement between said reference timing cycle and said subordinate timing cycle;
determining a phase displacement differential between said first phase displacement and said subsequent phase displacement; and,
adjusting the frequency of said subordinate timing cycles by a percentage of said phase displacement differential.

2. The method of claim 1 in which said frequency of said subordinate timing cycles is adjusted by a predetermined percentage of said phase displacement differential.

3. The method of claim 1 in which a pre-determined number of successive phase displacement differentials must be in agreement before the frequency of said subordinate clock timing cycle is adjusted.

4. The method of claim 1 in which a predetermined percentage of successive phase displacement differentials must be in agreement before said subordinate clock timing cycle is adjusted.

5. The method of claim 1 wherein said synchronization signal is carried on a seismic data interrogate signal transmitted by a central recording unit to a plurality of remote data acquisition modules.

6. The method of claim 1 wherein said method commences at the beginning of a period of activation of seismic data recording and ceases at the end of said period.

7. The method of claim 1 in which said method commences substantially prior to the beginning of a period of activation of seismic data recording so that remote clock stability is achieved prior to commencement of recording.

8. The method of claim 1 in which said clocks are elements of a seismic data acquisition network comprising communication pathways along electrical cable.

9. The method of claim 1 in which said clocks are elements of a seismic data acquisition network comprising communication pathways carried by radio waves.

10. The method of claim 1 in which said clocks are elements of a seismic data acquisition network comprising communication pathways carried by light waves.

11. In a network connected system comprising a reference clock and one or more subordinate clocks, the combination comprising:
reference clock means for generating and transmitting a synchronization signal comprising a first delineated sequence of reference timing cycles;
subordinate clock means for generating a second delineated sequence of subordinate timing cycles substantially corresponding to said reference timing cycles;
first means for receiving said synchronization signal by said subordinate clock;
second means for comparing and recording a first phase displacement between a reference timing cycle and a subordinate timing cycle;
third means for comparing and recording a subsequent phase displacement between said reference timing cycle and said subordinate timing cycle;
fourth means for determining a phase displacement differential between said first phase displacement and said subsequent phase displacement; and, fifth means for adjusting the frequency of said subordinate timing cycles by a percentage of said phase displacement differential.

12. The system of claim 11 wherein said fifth means adjusts the frequency of said subordinate timing cycles by a predetermined percentage of said phase displacement differential.

13. The system of claim 11 comprising a seismic data acquisition system wherein said reference clock is a system master clock and said subordinate clock is combined with a seismic data acquisition module.

14. The system of claim 11 wherein said fourth means is programmed to find a pre-determined number of successive phase displacement differentials in agreement before the frequency of said subordinate clock timing cycle is adjusted.

15. The system of claim 11 in which said forth means is programmed to find a predetermined percentage of successive phase displacement differentials in agreement before said subordinate clock timing cycle is adjusted.

16. The system of claim 11 in which said clocks are elements of a seismic data acquisition network comprising communication pathways along electrical cable.

17. The system of claim 11 in which said clocks are elements of a seismic data acquisition network comprising communication pathways carried by radio waves.

18. The system of claim 11 in which said clocks are elements of a seismic data acquisition network comprising communication pathways carried by light waves.

19. The system of claim 11 wherein said synchronization signal is carried by a seismic data interrogation signal.
